(19) United States
(12) Patent Application Publication
(10) Pub. No.: US 2007/0130390 A1
(43) Pub. Date: Jun. 7, 2007

(54) Method and apparatus for effective package memory bandwidth management

(76) Inventor: Yi-Hsien Hao, Saratoga, CA (US)

Correspondence Address: YI-HSIEN HAO, 12291 MABEL CT., SARATOGA, CA, 95070, US

(21) Appl. No.: 11/284,984

(22) Filed: Nov. 21, 2005

(51) Int. Cl. G06F 5/00

(52) U.S. Cl. 710/52

(57) ABSTRACT

A high speed electronic system which uses memory (package memory) to store package may be forced to use more expensive higher speed, or dual port memory to increase bandwidth. The present invention provides a method to more effectively manage the package memory using same memory technology. Hence it can provide more memory bandwidth at lower cost. The method includes using multiple package memories and multiple buffer control modules in the said electronic system. The method also includes a novel buffer control method, which can effectively manage buffer request and buffer return operations of the said electronic system.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

The invention relates to a memory system and method for effectively managing package memory bandwidth in an electronic system, such as network switch, or computer system.

Numerous electronic systems, for example, a Ethernet switch, or a computer system, may need to receive packages, store it to the package memory, process it, and then sent that package out. Such a system may include input module, which can receive incoming package, may include package memory, for example, semiconductor RAM, to store the received package, may include central control module to process and control that package and may also include output module, which can read package from package memory, then send the package out. When the input module stores a package to package memory, a write operation will be applied to the package memory by the system. When the output module sends out the package, a read operation will be applied to the package memory by the system.

The said electronic system may have multiple input modules and multiple output modules. In some cases, a package, received from one input module may be required to be sent to multiple or all output modules. When it happens, the received package will need one package memory write operation, and multiple package memory read operations, depends on number of output modules which need to send out this package.

To effectively manage the package memory, the package memory usually is logically divided into several fixed size buffers. The size of the buffer, for example, 128 byte or 256 byte, is depending on specific application requirements. By logically dividing the package memory into smaller number of buffers, the package memory managing task now become easier. For example, if package memory size is 256K byte, and buffer size is 256 byte, then the total number of buffer will be 1K. Instead of managing 256K byte data, only 1 K buffer needs to be managed now. So in this example, if an input module holds two free buffers, which means the input module own 256×2=512 byte of memory space in package memory.

To manage the buffers, the said memory system needs to have a buffer control module, which is capable of allocating buffers to each input module before a package arrives and is capable of returning buffers when package are no longer needed by output modules. To manage buffers effectively, each buffer has a unique ID associated to it. The buffer control module has an internal data base to keep track of which buffer has been allocated, and which buffer is still available for allocation. The internal data base can be implemented with memory, or registers. And each buffer may be represented by several bits of memory, or registers, depending on the implementation. After system reset, all buffers are available. When a buffer has been allocated to an input module, that buffer in the buffer control module data base will be marked as used. When a buffer has been returned by all involved output modules, it will be marked as available. Since buffer allocation and buffer return will work on same data base, they can not work at same time. So buffer control module need to arbitrate those two operations. To avoid returned buffers from been lost, buffer control module usually give buffer return operations (initiated by output modules) higher priority than buffer allocation operations (initiated by input modules). Usually each package memory need one buffer control module to manage its memory, i.e. to allocate free buffers (free package memory space) to input modules, and to collect returned buffers from output modules, so buffer control module can allocate it again.

Before receiving a new package, each input module needs to request enough free buffers(free space in package memory) to store the incoming package completely onto Package memory. Otherwise the incoming package will not have enough buffer memory to store package data. Consequently, the package will be dropped. Each received package may need one or multiple free buffers, depends on the size of package. Usually the input module will prepare enough number of free buffers such that it can store the largest possible package it may receive.

Some received package from the input module may need be sent out by multiple or all output modules. When that happens, the used buffers need be returned multiple times to buffer control module. If an incoming package need Y buffers and that package only need be send out by one output module, then the buffer control module only need to support (1×Y) buffer allocation operations and (1×Y) buffer return operations. However, if that package need be transmitted by multiple output modules, the buffer control module need to support (1×Y) buffer allocation operations and (1×Y×N) return buffer operations. N is the number of output modules which need to send out this package. For a high speed electronic system, if a lot of incoming packages need be sent out by multiple output modules, then the buffer control module need to handle lots of high priority buffer return operations(buffer return traffic), which may stall low priority buffer allocation operations(buffer allocation traffic) if buffer control module do not have enough bandwidth. When buffer allocation operation get stalled, some input modules may not have enough buffers to store incoming package, and will cause incoming packages been dropped, which will cause performance degradation.

The required size of package memory usually is very big. For cost reason, most of package memory is implemented with the cheapest memory. For example, a low speed single port RAM. If the system needs more bandwidth to support more input modules and output modules, or to support higher speed traffic, for example 10 G Ethernet traffic through input modules or output modules, the conventional method is to use either higher speed RAM, or dual port RAM. Higher speed RAM allow faster memory read and write operations, thus it can provide more bandwidth. Dual port RAM allow memory read and write operation to occur simultaneously, thus it can also support more bandwidth. However, high speed RAM and dual port RAM are more expensive to implement, especially if the package memory size is big.

Therefore, what is needed is a novel package memory management method, which can manage a package memory more effectively and provide more memory bandwidth to the memory system using existing memory technology.

### BRIEF SUMMARY OF THE INVENTION

Other objects and advantages of the present invention will become apparent from the following descriptions, taken in connection with the accompanying drawings, wherein, by way of illustration and example, an embodiment of the present invention is disclosed.

The present invention provides a method to split the package memory into multiple pieces of package memories. Each piece of the split package memory stores part of total package. Since those split package memories are physically separated, they can allow concurrent access of those memories by different input modules and output modules. To effectively manage the split package memory, the present invention also provides a method to split the buffer control module into several new buffer control modules. All split buffer control modules work together to manage all buffer allocation and buffer return operations. The present invention further provides a method to resolve the problem caused by worst case high buffer return traffic, which happens when lots of packages received by an input modules need be send out (transmit) by multiple output modules.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

The objects and features of this invention will be more readily understood with reference to the following descriptions and the attached drawings, wherein:

FIG. 1 illustrates an example of a simplified electronic system.

FIG. 2 illustrates an example of a simplified buffer control module, which is described in FIG. 1.

FIG. 3 illustrates a simplified diagram of an electronic system according to one embodiment of the present invention.

FIG. 4 illustrates an example of the buffer control module, which is described in FIG. 3. This buffer control module is implemented according to one embodiment of the present invention.

FIG. 5 illustrate another simplified diagram of an electronic system according to one embodiment of the present invention.

FIG. 6 illustrates an example of the buffer control module described in FIG. 5. This buffer control module is implemented according to one embodiment of the present invention.

Use of the same reference symbols in different figures indicates similar or identical items.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

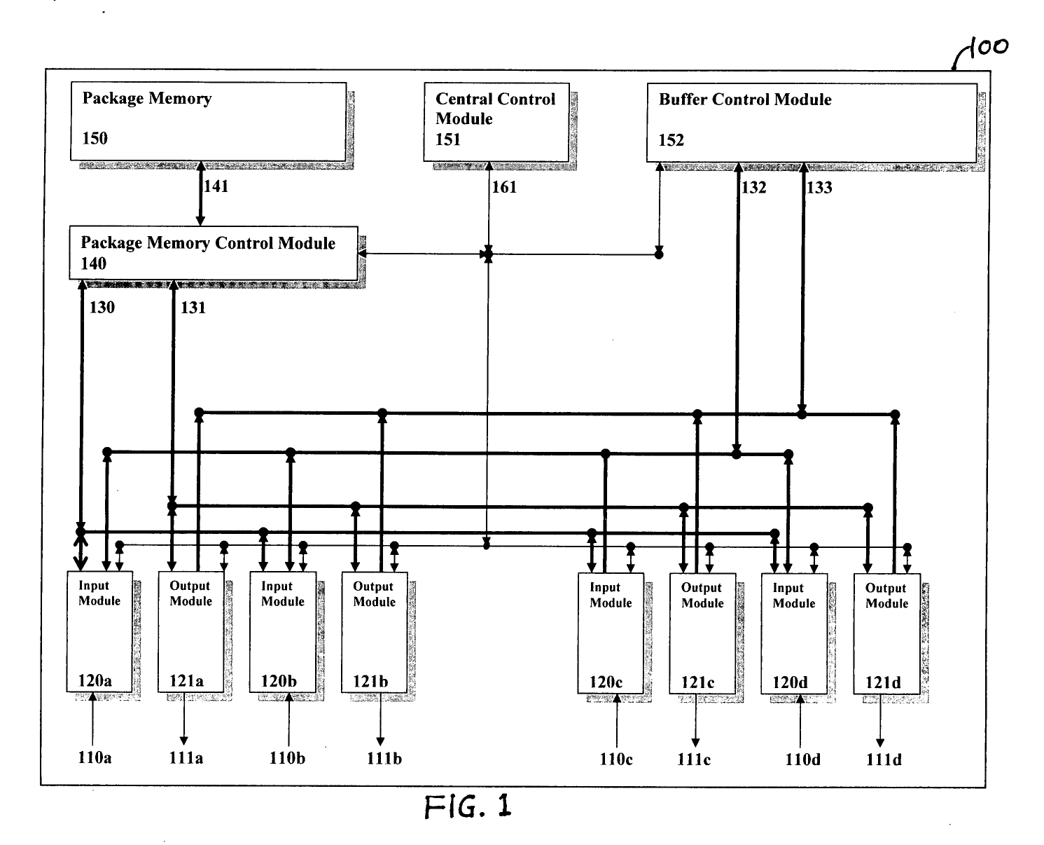

FIG. 1 illustrates a simplified , conventional electronic system 100, which includes four input ports 110(a-d), four output ports 111(a-d), four input modules 120(a-d), four output modules 121(a-d), a input module to package memory control module bus 130, a output module to package memory control module bus 131, a package memory control module 140, a package memory control module to package memory bus 141, a package memory 150, a buffer control module 152, a input module to buffer control module bus 132, a output module to buffer control module bus 133, a central control module 151, a central control module control bus 161 . The central control module 151 can control the whole electronic system 100, for example, it can process package stored in the package memory 150, instruct the output modules 121(a-d) to transmit package from the package memory 150 to some external devices (not shown) through output ports 111(a-d).

The input module 120(a-d) is capable of allocating free buffers from the buffer control module 152 before each incoming package arrives. The input module 120(a-d) uses bus 132 to request for free buffers. Once getting grant from the buffer control module 152, the input module 120(a-d) can receive free buffers through bus 132. Those free buffers will be used to store incoming package. The buffer control Module 152 can grant single buffer or multiple buffers to the input module 120(a-d). When the input module 120(a-d) receive an incoming package from the external device (not shown) through input port 11 0(a-d), it may process the package before writing package to the package memory 150 through the bus 130. Once gaining grant from the package memory control module 140, the input module 120(a-d) can send package to the package memory 150 through the bus 130.

When the output module 121(a-d) needs to transmit a package from the package memory 150 to the external device (not shown) through the output port 111(a-d), it will wait for grant from the package memory control module 140, Once gaining grant from the package memory control module 140, the output module 121(a-d) will read package from the package memory 150. The output module 121(a-d) may process the package before sending it to the external devices (not shown) through the output port 111(a-d).

When the buffers used by the output module 121(a-d) to send out package are no longer needed, the output module 121(a-d) will return those buffers to the buffer control module 152. The output module 121(a-d) will use the bus 133 to request for buffer return. Once been granted by the buffer control module 152, the output module 121(a-d) will return buffers to the buffer control module 152 through the bus 133.

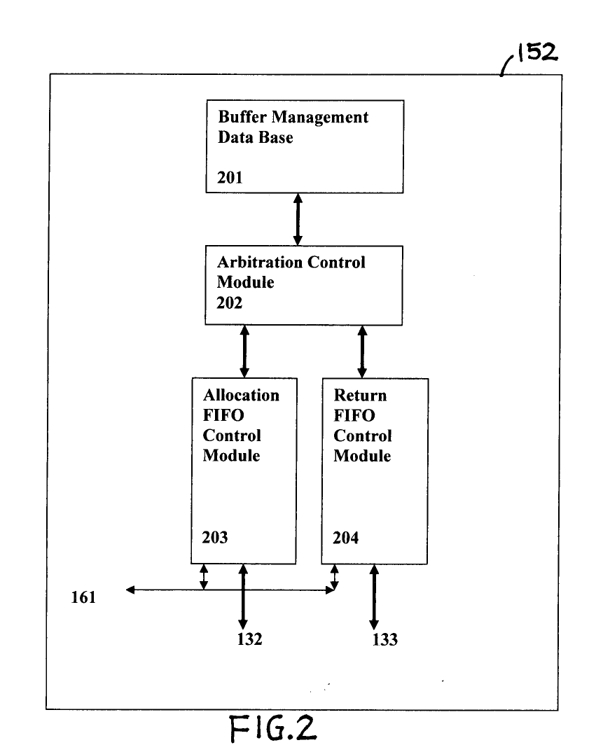

FIG. 2 illustrates one of the conventional implementation of the buffer control module 152. The buffer management data base module 201 always keeps track of the status of each buffer. It knows which buffer is available for allocation, which buffer is been allocated and waiting for buffer return. The arbitration control module 202 is capable of controlling the allocation FIFO control module 203 and the return FIFO control module 204. Only one of them can access the buffer management data base module 201 at any time. The allocation FIFO control module 203 is capable of requesting free buffers from the buffer management data base module 201 if its internal FIFO (not shown) is not full. Once getting free buffers, the allocation FIFO control module 203 will store free buffers into its internal FIFO (not shown). The allocation FIFO control module 203 also handles the control function, which will assign allocated free buffers to each input module 120(a-d) through the bus 132(a-d). The return FIFO control module 204 is capable of controlling the buffer return function. It controls the return buffers from the output modules 121(a-d) through the bus 133. Then store the return buffers in its internal FIFO (not shown). Once the internal FIFO (not shown) is not empty, it will ask the arbitration control module 202 to return buffers to the buffer management data base module 201. If the return FIFO (not shown) is overrun, some return buffers will be lost. Once some return buffers been lost, the system 100 will have fewer buffers to store package. Once system 100 lost its entire buffers, it can no longer function correctly. For this reason, the arbitration control module 202 usually will give the return FIFO control module 204 higher priorities over the allocation FIFO control module 203 to access the buffer management data base 201.

When a package been received by one of the input module, for example the module 120a, and if that package only need be transmitted to one of output module, for example module 121b, then the buffer management data base 201 will experience buffer allocation traffic for that package once, and buffer return traffic for that package once. However, if that package need be transmitted by several output modules, for example module 121b, 120c, 120d, then the buffer management data base module 201 will experience three times return traffic from that package. This traffic increase is caused by each of the output module 121b,121c,121d needs to return same buffers once. The return buffer traffic increase may become worse if system 100 has to support more output modules, for example, to support 20 output modules.

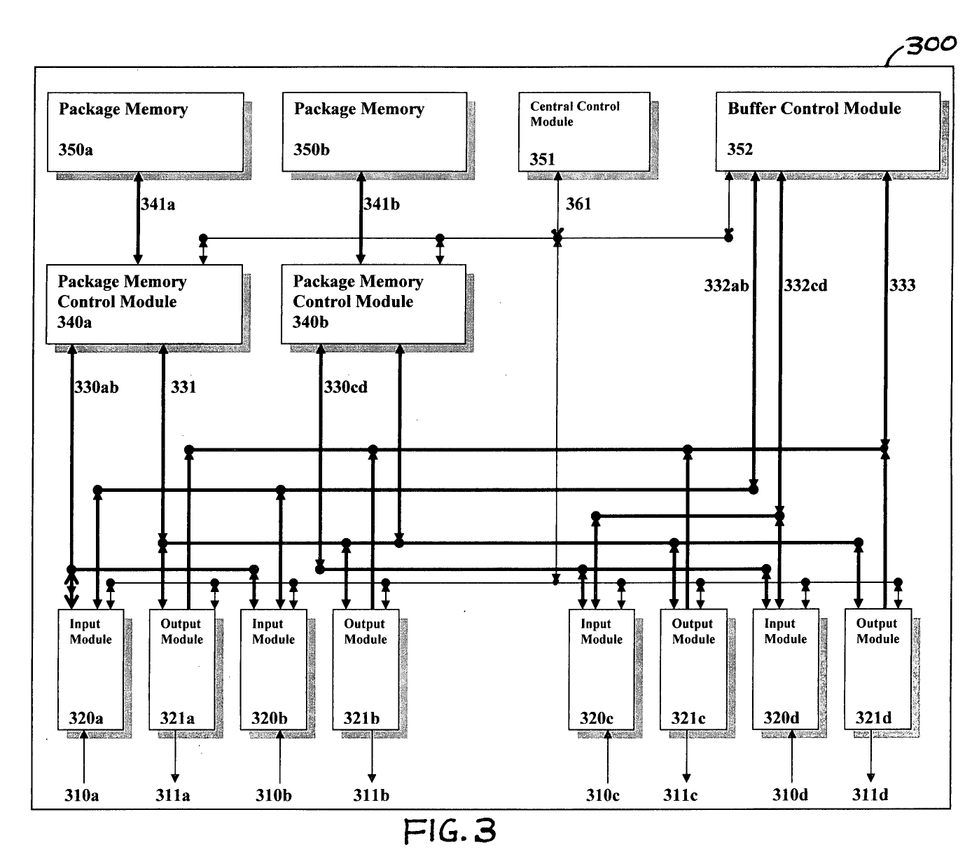

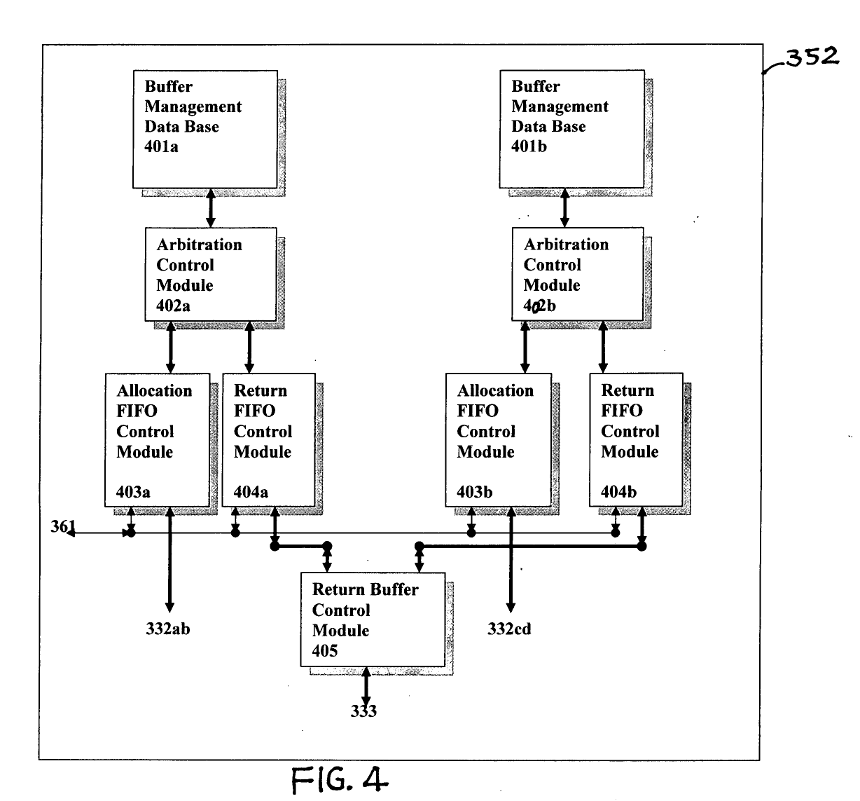

When system 100 needs to support more input modules and output modules, or need to support faster input ports and output ports, the bandwidth requirements on package memory 150 and buffer control module 152 will be increased accordingly. The easiest and conventional way of increasing memory bandwidth is to use faster package memory, or use dual port RAM. However, faster memory and dual port memory are more expensive and will increase system cost a lot if big package memory is needed. One solution provided by the present invention to increasing the bandwidth of package memory 150 is to physically split package memory into several smaller package memories. Each new split package memory only support certain input modules. For example, using two package memories. Each memory only supports 50% of input modules to store incoming package. Since each package memory support reduced input modules, the bandwidth requirement on each package memory is reduced. In order to support split package memories, the buffer control module also need be split accordingly. FIG. 3 and FIG. 4 will give more detail descriptions on one embodiment of the present invention.

FIG.3 illustrates a simplified diagram of an electronic system 300 according to one embodiment of the present invention. System 300 uses two set of package memories and two set of buffer control modules to reduce bandwidth requirement on each package memory. System 300 includes four input ports 310(a-d), four output ports 311(a-d), four input modules 320(a-d), four output modules 321(a-d), two input module to package memory control module bus 330ab and 330cd, a output module to package memory control module bus 331, two package memory control modules 340(a-b), two package memory control module to package memory bus 341 (a-b), two package memories 350(a-b), a buffer control module 352, two input module to buffer control module bus 332ab and 332cd, an output module to buffer control module bus 333, a central control module 351, a central control module control bus 361.

The central control module 351 is capable of controlling the whole electronic system 300. For example, it can process the packages stored in the package memory 350(a-b), command the output modules 321(a-d) to transmit package from the package memory 350(a-b) to an external device (not shown) through the output ports 311(a-d).

Before receiving a new package from the input port 310(a-b), the input module 320(a-b) will request enough buffers from the buffer control module 352. The buffer control module 352 always allocates free buffers from the package memory 350a for the input module 320(a-b). Similarly, before receiving a new package from the input port 310(c-d), the input module 320(c-d) will request enough buffers from the buffer control module 352. The buffer control module 352 always allocates buffers from the package memory 350b for the input module 320(c-d).

After sending out each package, each output module 321(a-d) needs to return used buffers back to the buffer control module 352 through bus 333.

FIG. 4 illustrates one of the possible implementation of the buffer control module 352 according to one embodiment of the present invention. The buffer management data base module 401a and 401b are capable of managing all available buffers in the system 300. Each buffer management data base module 401(a-b) can handle a portion of total buffers. For example, each one can handle 50% of the total buffers. The buffer management data base module 401(a-b) always keeps track of the status of each buffer. It knows which buffer is available for allocation, which buffer is been allocated and waiting for buffer return. Each buffer has a unique ID, and part of that ID can be used to identify if it is from buffer management data base module 401a, or 401b. For example, if the buffer ID[0]=1, then it is from the buffer management data base module 401a, if the buffer ID[0]=0, it is from the buffer management data base module 401b.

The arbitration control module 402(a-b) is to control the allocation FIFO control module 403(a-b) and the return FIFO control module 404(a-b). Only one of them can access the buffer management data base module 401(a-b) at any time. To avoid return buffers from being lost, the arbitration control module 402(a-b) will give the return FIFO control module 404(a-b) higher priority to access the buffer management data base module 401(a-b).

The allocation FIFO control module 403a will keep on requesting free buffers from the buffer management data base module 401a if its internal FIFO (not shown) is not full. Once getting a free buffer, the allocation FIFO control module 403a will store that free buffer in its internal FIFO. The allocation FIFO control module 403a will also handle the control function which assign the allocated free buffers to each input modules 320(a-b) through the bus 332ab. Similarly, the allocation FIFO control module 403b will keep on requesting free buffers from the buffer management data base module 401b if its internal FIFO (not shown) is not full. Once getting free buffers, the allocation FIFO control module 403b will store those free buffers in its internal FIFO. The allocation FIFO control module 403b will also handle the control function, which will assign allocated free buffers to each input modules 320(c-d) through the bus 332cd. The function of return FIFO control module 404(a-b) is to handle the return buffers. It control the return buffers assigned by the return buffer control module 405, then store the return buffers in its internal FIFO (not shown). Once internal FIFO (not shown) is not empty, the return FIFO control module 404(a-b) will ask the arbitration control module 402(a-b) to return buffers to the buffer management data base module 401(a-b).

The return buffer control module 405 has interfaces to all output modules 321(a-d) through bus 333. The return buffer control module 405 will pick up return buffers from one of output module 321(a-d), then look at the buffer ID. Based on the buffer ID, the return buffer control module 405 will decide to return buffers to either the return FIFO control module 404a, or 404b.

As shown in FIG. 3 and FIG. 4, the system 300 can reduce bandwidth requirements on package memory by using two set of package memory 350(a-b) and two set of buffer control modules. Ideally, each set will handle portion of system 300 total traffic. For example, each set can handle 50% traffic. However, the buffer control module 352 of this implementation, as shown in FIG. 4 still may have some bandwidth problem as described herein below.

In the system 100, the buffer management data base module 201 needs to allocate buffer for four input modules. However, each of the buffer management data base module 401(a-b) in the system 300 only need to allocate buffers to two input modules. So the buffer allocation traffic to each of the buffer management data base module 401(a-b) get reduced by 50%. However, the worst case buffer return traffic to each buffer management data base module in the system 100 and system 300 are still the same. This is because the worst case return traffic happens when one incoming package need be transmitted by all output modules. When all output modules no longer need package buffers, they will return buffers to the same buffer management data base module who has grant the buffers to the input module. Since numbers of output modules are the same in the system 100 and system 300, the worst case return traffic to each buffer management data base module remains the same. If return buffer traffic take away most of bandwidth from the buffer management data base bandwidth, the allocation FIFO control module 403(a-b) may not get enough free buffers. When that happens, input module may be forced to drop packages. Therefore, a new method of managing the worst case return buffer traffic is needed in order to further reduce the bandwidth requirement of the buffer control module 352.

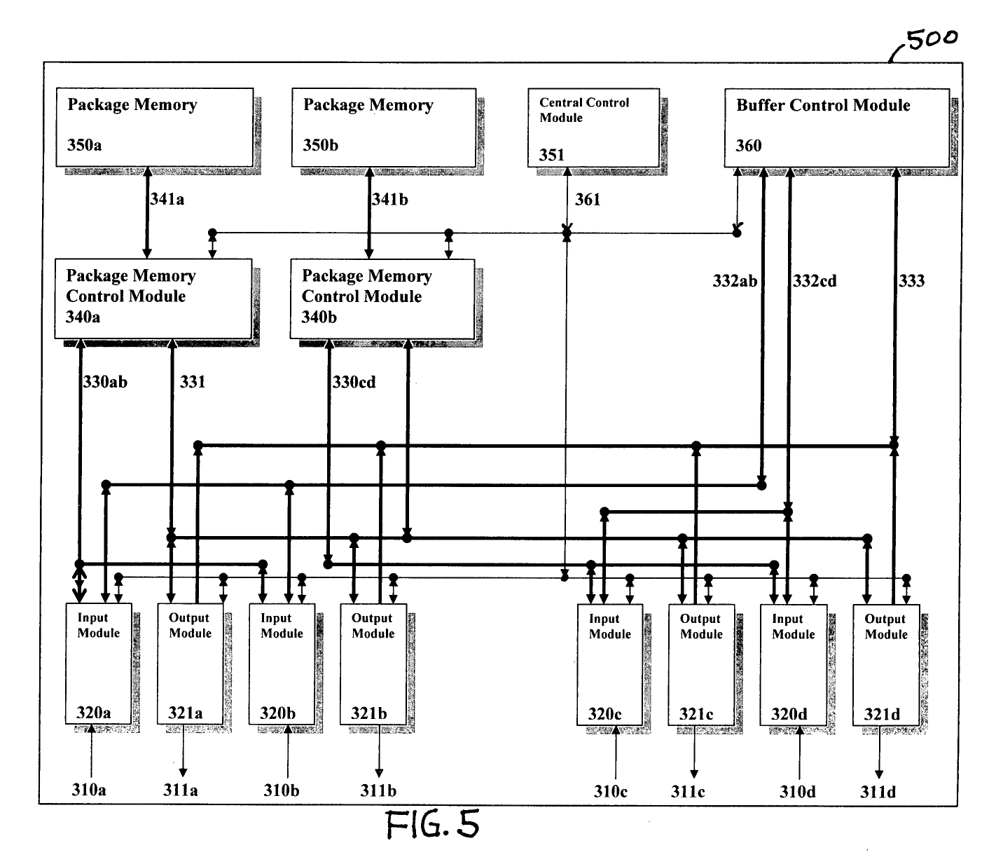

FIG. 5 illustrates a simplified electronic system 500 according to one embodiment of the present invention. The system 500 is the same as the system 300, except the buffer control module 352 in the system 300 is replaced by an enhanced, new buffer control module 360.

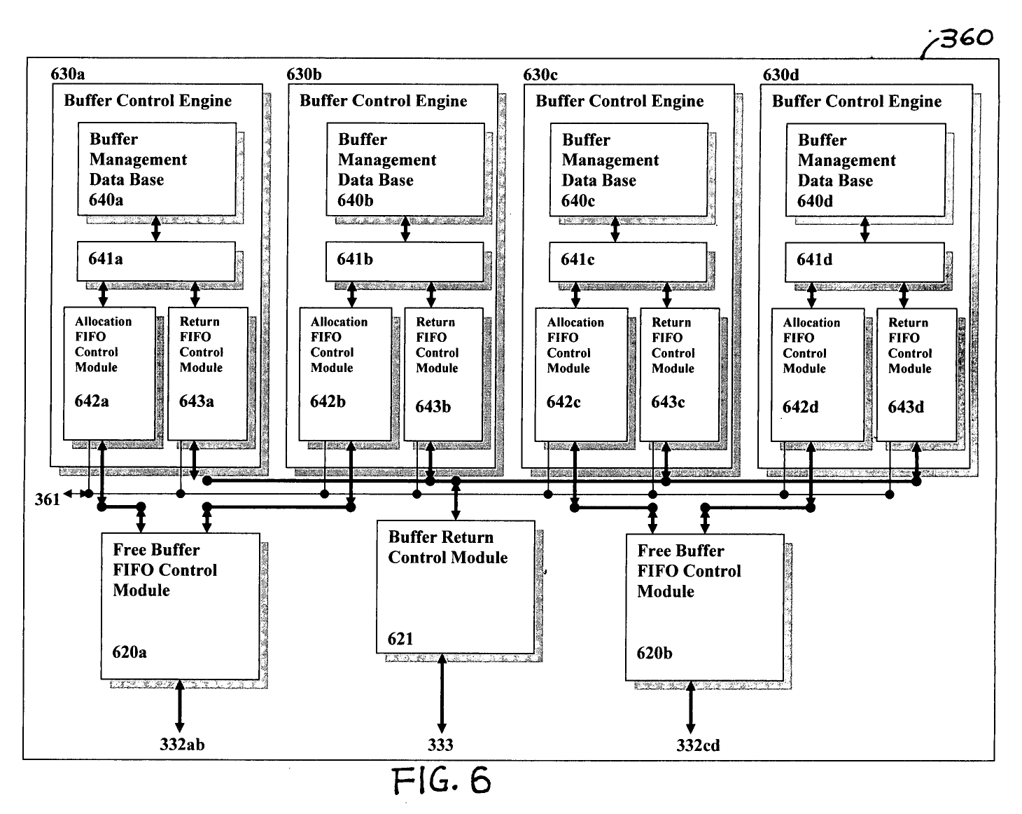

FIG. 6 illustrates a simplified diagram of the buffer control module 360 according to one embodiment of the present invention. This buffer control module 360 comprises: two buffer allocation bus 332ab and 332cd, a buffer return bus 333, two free buffer FIFO control modules 620(a-b), a buffer return control module 621, four buffer control engines 630(a-d).

In FIG. 6, the function of the buffer control engine 630(a-d) is similar to combined functions of module 401(a-b), 402(a-b), 403(a-b), and 404(a-b) in FIG. 4. Each buffer control engine 630(a-d) comprises: a buffer management data base module 640(a-d), a arbitration control module 641(a-d), an allocation FIFO control module 642(a-d) and a return FIFO control module 643(a-d). In this simplified diagram, all buffer management data base 640(a-d) are used to manage all available buffers in system 500. Each buffer management data base 640(a-d) handles a portion of total buffers, for example 25% of total buffer. Each buffer handled by each buffer management data base module 640(a-d) can be identified by the buffer ID. For example: all buffers with buffer ID[1:0]=00 are managed by module 640a, all buffers with buffer ID[1:0]=01 are managed by module 640b, all buffers with buffer ID[1:0]=10 are managed by module 640c, and all buffers with buffer ID[1:0]=11 are managed by module 640d. In this example, the buffer control engine 630a and 630b are used to manage the package memory 350a and the buffer control engine 630c and 630d are used to manage the package memory 350b. In other application, the mapping between the buffer control engines and the package memories may be different.

The free buffer FIFO control module 620a is capable of collecting the buffers from the allocation FIFO control module 642a and 642b. Then the collected buffers will be sent to input module 310(a-b) through bus 332ab when input module 310(a-b) request for buffers. Similarly, the free buffer FIFO control module 620b is capable of collecting the buffers from the allocation FIFO control module 642c and 642d. Then the collected buffers will be sent to input module 310(c-d) through bus 332cd when input modules 310(c-d) request for buffers. The buffer return control module 621 is capable of arbitrating return buffer requests from all output modules 311(a-d). The output modules use the bus 333 to pass return buffers to the buffer return control module 621. The buffer return control module 621 then pass the return buffers to one of return FIFO control module 643(a-d), based on the return buffer ID.

In the system 500, if a package received by one of input module, for example module 320a, and if that package needs be transmitted by multiple output modules, for example module 321b, 321c,321d, then the worst case buffer return traffic will happen when all buffer return traffic all go to one buffer management data base module, for example, the buffer management data base module 640a. When this case happens, the buffer management data base module 640a may be forced to handle the buffer return traffic and may not have enough bandwidth to support the buffer allocation traffic. However, since the system 500 uses the free buffer FIFO control module 620a to allocate buffers to input module 321(a-b), and the free buffer FIFO control module 620a has two sources to get free buffers: one from the allocation FIFO control module 642a and another from the module 642b. If the allocation FIFO control module 642a can not supply free buffers to the free buffer FIFO control module 620a due to huge buffer return traffic from the return FIFO control module 643a, the free buffer FIFO control module 620a still can get free buffers from the allocation FIFO control module 642b.

Since the worst case buffer return traffic may only go to either the return FIFO control module 643a, or the return FIFO control module 643b, it can be sure that if the return FIFO control module 643a get huge traffic, the return FIFO control module 643b shall get very light traffic. If the return FIFO control module 643b has light traffic, then the allocation FIFO control module 642b shall get enough bandwidth to allocate free buffers from buffer management data base module 640b. So the free buffer FIFO control module 620a can still get free buffers. Similarly, if the allocation FIFO control module 642b can not supply free buffers to module free buffer FIFO control 620a due to huge return traffic on the return FIFO control module 643b, the free buffer FIFO control module 620a can still get free buffers from the allocation FIFO control module 642a.

There is another advantage of this new invention. Consider the previous case. If most of the buffer return traffic go to the return FIFO control module 643a at a time, which will cause the allocation FIFO control module 642a not been able to provide enough free buffers. When that happens, the free buffer FIFO control module 620a will get most of allocated free buffer from the allocation FIFO control module 642b. Once most of allocated buffers are from the allocation FIFO control module 642b, most of the following buffer return traffic will be shifted from module 643a to module 643b (return buffers shall be returned to the same buffer control management data base where they are allocated). If worst case buffer return traffic continuously happen, this invention will automatically alternate buffer allocation traffic and buffer return traffic between two buffer control engines. So as long as each of the buffer control engine 630(a-d) can handle worst case return traffic, the system 500 can guarantee all input modules will get enough free buffers, and each input module will not drop packages due to lack of enough free buffers.

In system 300, a method is introduced to reduce package memory 350(a-b) bandwidth requirements and reduce the buffer management data base module 401(a-b) bandwidth requirements. However, the worst case buffer return traffic may still dominate most of the buffer management data base module 401(a-b) bandwidth. When that happens, the allocation FIFO control module 403(a-b) may not be able to allocate enough free buffers to input modules, and will cause incoming packages been dropped. The buffer management data base 401(a-b) needs to support combined worst case buffer return traffic and worst case buffer allocation traffic.

In system 500, another method is introduced for the buffer control module 360. In this new invention, dual buffer control engines are used for each package memory. By doing so, if one return FIFO control module 643(a-d) in one buffer control engine dominate the bandwidth of the management data base module 640(a-d), the system 500 can still get free buffers from the allocation FIFO control module 642(a-d) in another buffer control engine. The bandwidth required for each buffer management data base 640(a-d) is reduced to the worst case buffer return traffic.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A package memory system comprising:
at least two input modules to receive packages, process the packages, then store the packages to a coupled package memory;
at least two output modules to fetch a packages from the coupled package memory, then process the packages and send out the packages to external devices;
at least two package memories, which are logically divided into several smaller fixed size buffers, to store packages received from the coupled input modules;
at least two buffer control engines to keep track of the status of all buffers in the package memory system, each buffer control engine manages a portion of the package memory;
a free buffer FIFO control module to collect the free buffers from the coupled buffer control engines, and allocate free buffers to the coupled input modules; and
a buffer return control module to handle all buffer return requests from the coupled output modules, and send the return buffers back to one of the coupled buffer control engine.

2. The package memory system of claim 1, wherein each of the buffer control engine further comprising:
a buffer management data base which is capable of keeping track of each buffer's status and providing free buffers to an coupled allocation FIFO control module, as well as capable of receiving return buffers from a return FIFO control module;
an arbitration control module to control the accessing of the buffer management data base;
an allocation FIFO control module to fetch free buffers from the buffer management data base and provide free buffers to the coupled free buffer FIFO control module; and
a return FIFO control module to handle the return buffer operation initiated by the output modules, and send back the return buffers to the buffer management data base.

3. The package memory system of claim 1, wherein each of the buffer control engine can allocate free buffers to the coupled input modules, and can take the return buffers from the coupled output modules.

4. The package memory system of claim 1, wherein each of the package memory is controlled by at least two buffer control engines.

5. The package memory system of claim 1, wherein each of the free buffer FIFO control module can fetch free buffers from each of the coupled buffer control engines, and allocate free buffers to the coupled input modules.

6. The package memory system of claim 1, wherein even if one buffer control engine's bandwidth is completed consumed by the return buffer traffic, the free buffer FIFO control module can still get free buffers from the other buffer control engines which are coupled to it.
